(19) United States
(12) Patent Application Publication
(10) Pub. No.: US 2013/0238851 A1
(43) Pub. Date: Sep. 12, 2013

(54) HYBRID STORAGE AGGREGATE BLOCK TRACKING

(71) Applicants: Koling Chang, Davis, CA (US); Rajesh Sundaram, Mountain View, CA (US); Douglas P. Doucette, San Diego, CA (US); Ravikanth Dronamraju, Pleasanton, CA (US)

(72) Inventors: Koling Chang, Davis, CA (US); Rajesh Sundaram, Mountain View, CA (US); Douglas P. Doucette, San Diego, CA (US); Ravikanth Dronamraju, Pleasanton, CA (US)

(73) Assignee: NetApp, Inc., Sunnyvale, CA (US)

(21) Appl. No.: 13/413,877

(22) Filed: Mar. 7, 2012

(51) Int. Cl. G06F 12/08

(52) U.S. Cl. 711/113; 711/E12.017

(57) ABSTRACT

Methods and apparatuses for operating a hybrid storage aggregate are provided. In one example, such a method includes operating a first tier of physical storage of the hybrid storage aggregate as a cache for a second tier of physical storage of the hybrid storage aggregate. The first tier of physical storage includes a plurality of assigned blocks. The method also includes updating metadata of the assigned blocks in response to an event associated with at least one of the assigned blocks. The metadata includes block usage information tracking more than two possible usage states per assigned block. The method can further include processing the metadata to determine a caching characteristic of the assigned blocks.

### TECHNICAL FIELD

Various embodiments of the present application generally relate to the field of operating data storage systems. More specifically, various embodiments of the present application relate to methods and systems for allocating storage space in a hybrid storage aggregate.

### BACKGROUND

The proliferation of computers and computing systems has resulted in a continually growing need for reliable and efficient storage of electronic data. A storage server is a specialized computer that provides storage services related to the organization and storage of data. The data managed by a storage server is typically stored on writable persistent storage media, such as non-volatile memories and disks. A storage server may be configured to operate according to a client/server model of information delivery to enable many clients or applications to access the data served by the system. A storage server can employ a storage architecture that serves the data with both random and streaming access patterns at either a file level, as in network attached storage (NAS) environments, or at the block level, as in a storage area network (SAN).

The various types of non-volatile storage media used by a storage server can have different latencies. Access time (or latency) is the period of time required to retrieve data from the storage media. In many cases, data are stored on hard disk drives (HDDs) which have a relatively high latency. In HDDs, disk access time includes the disk spin-up time, the seek time, rotational delay, and data transfer time. In other cases, data are stored on solid-state drives (SSDs). SSDs generally have lower latencies than HDDs because SSDs do not have the mechanical delays inherent in the operation of the HDD. HDDs generally provide good performance when reading large blocks of data which is stored sequentially on the physical media. However, HDDs do not perform as well for random accesses because the mechanical components of the device must frequently move to different physical locations on the media.

SSDs use solid-state memory, such as non-volatile flash memory, to store data. With no moving parts, SSDs typically provide better performance for random and frequent memory accesses because of the relatively low latency. However, SSDs are generally more expensive than HDDs and sometimes have a shorter operational lifetime due to wear and other degradation. These additional up-front and replacement costs can become significant for data centers which have many storage servers using many thousands of storage devices.

Hybrid storage aggregates combine the benefits of HDDs and SSDs. A storage “aggregate” is a logical aggregation of physical storage, i.e., a logical container for a pool of storage, combining one or more physical mass storage devices or parts thereof into a single logical storage object, which contains or provides storage for one or more other logical data sets at a higher level of abstraction (e.g., volumes). In some hybrid storage aggregates, SSDs make up part of the hybrid storage aggregate and provide high performance, while relatively inexpensive HDDs make up the remainder of the storage array. In some cases other combinations of storage devices with various latencies may also be used in place of or in combination with the HDDs and SSDs. These other storage devices include non-volatile random access memory (NVRAM), tape drives, optical disks, and micro-electro-mechanical (MEMs) storage devices. Because the low latency (i.e., SSD) storage space in the hybrid storage aggregate is limited, the benefit associated with the low latency storage is maximized by using it for storage of the most frequently accessed (i.e., “hot”) data. The remaining data are stored in the higher latency devices. Because data and data usage change over time, determining which data are hot and should be stored in the lower latency devices is an ongoing process. Moving data between the high and low latency devices is a multi-step process that requires updating of pointers and other information that identifies the location of the data.

Lower latency storage is often used as a cache for the higher latency storage. In some cases, copies of the most frequently accessed data are stored in the cache. When a data access is performed, the faster cache may first be checked to determine if the required data are located therein, and, if so, the data may be accessed from the cache. In this manner, the cache reduces overall data access times by reducing the number of times the higher latency devices must be accessed. In some cases, cache space is used for data which is being frequently written (i.e., a write cache). Alternatively, or additionally, cache space is used for data which is being frequently read (i.e., read cache). The policies for management and operation of read caches and write caches are often different.

The demands placed upon a storage system will typically change over time due to changes in the amount of data stored, the types of data stored, how frequently the data are accessed, as well as for other reasons. The performance of the storage system will also typically change under these changing conditions. In the case of hybrid storage aggregates, it is often beneficial to change the configuration and/or allocation of the low latency tier in order to meet the changing demands of the system. This allows the limited resources of the low latency tier to be dynamically allocated to meet the changing needs of the storage system. For example, a read cache of a particular size which was previously large enough to meet the needs of the storage system may no longer be large enough due to changing demands placed upon the system. Presently, while hybrid storage aggregates may track whether a particular block has been assigned or not, they do not track sufficient information to make these types of allocation decisions most effectively.

### SUMMARY

Hybrid storage aggregate performance may be improved by dynamically allocating the available storage space. The storage space which is available in the low latency tier of the storage aggregate can be reallocated to meet changing needs of the system. Tracking historical information about how the blocks of the low latency tier have been used is useful in making future decisions regarding how the available storage space in the low latency tier should be used in the future. Accordingly, methods and apparatuses for tracking detailed block usage in a hybrid storage aggregate are introduced here. In one example, such a method includes operating a first tier of physical storage of a hybrid storage aggregate as a cache for a second tier of physical storage of the hybrid storage aggregate. The first tier of physical storage includes a plurality of assigned blocks. The method includes updating metadata of the assigned blocks in response to an event associated with at least one of the assigned blocks. The metadata includes block usage information tracking more than two possible usage states per assigned block, for example, tracking more than just “free” or “used” states per block. For example, the system may track information about how the blocks are being used, such as whether each block is being used as a read cache, a write cache, or for other purposes. The method also includes processing the metadata to determine a caching characteristic of the assigned blocks.

In another example, a storage server system includes a processor and a memory. The memory is coupled with the processor and includes a storage manager. The storage manager directs the processor to operate a hybrid storage aggregate that includes a first tier of physical storage media and a second tier of physical storage media. The first tier of the physical storage media has a latency that is less than a latency of the second tier of the physical storage media. The storage manager directs the processor to assign a plurality of blocks of the first tier of physical storage. A first portion of the assigned blocks are operated as a read cache for the second tier of physical storage and a second portion of the assigned blocks are operated as a write cache for the second tier of physical storage. The storage manager also directs the processor to update metadata of the assigned blocks in response to an event associated with at least one of the assigned blocks. The metadata includes block usage information tracking more than two possible usage states per assigned block. The storage manager also directs the processor to process the metadata to determine a caching characteristic of the assigned blocks and change an allocation of the assigned blocks based on the caching characteristic.

In hybrid storage aggregates, read and write caches are often used to improve the performance of the associated storage system. A quantity of data storage blocks available in a low latency tier of the storage aggregate is typically assigned for use as cache. The assigned blocks may be used as read cache, write cache, or a combination. As the demands placed on the storage system change over time, the performance of the system may be improved by changing how the blocks in the low latency tier are assigned. In one example, changes in use of the system may be such that overall system performance will be improved if the size of at least one of the caches is increased. At the same time, the current usage of at least one of the caches may be such that its size may be reduced without significantly affecting the performance of the storage system. Making these types of determinations requires performing an accounting related to the usage of the blocks which makes up the caches. The accounting involves tracking the usage of the blocks and processing the usage information to determine use characteristics of the blocks.

The storage space available in the lower latency devices may be assigned for use as a read cache, a write cache, or a combination of read cache and write cache. In addition, in a hybrid storage aggregate which is used to store multiple volumes, the blocks may be assigned to different volumes of the hybrid storage aggregate. Over time, usage patterns and characteristics of the storage system may be such that a different assignment of the blocks of the lower latency storage tier may be more suitable and/or may provide better system performance. However, present hybrid storage aggregates do not track how blocks of the lower latency storage tier which are in use are being used. Present hybrid storage aggregates track whether or not a block of the lower latency tier has been assigned for use (i.e., whether the block is assigned or unassigned). In some cases, additional information about the unassigned blocks is tracked in order to balance usage of the blocks over time or to implement a chosen block recycling algorithm. Information about the unassigned blocks may be tracked in order to implement a first-in-first-out (FIFO) usage model, to implement a last-recently-used (LRU) algorithm, or to implement other recycling algorithms. However, additional information about how assigned blocks are being used is not tracked. Examples of information which is not tracked are the type of caching the block is being used for and how frequently the block is being accessed. Without this information, it is difficult to make strategic determinations regarding how allocations of the blocks should be changed in order to improve system performance.

The techniques introduced here resolve these and other problems by tracking more than two possible usage states per assigned block of the lower latency tier. For example, metadata associated with the blocks is updated to indicate how the blocks are being used. This metadata may include information indicating whether each block is being used as a read cache, a write cache, or for other purposes. The metadata may also include other types of information including which volume a block is assigned to and how frequently the blocks have been accessed. Many other types of usage information may be included in the metadata and the examples provided herein are not intended to be limiting. The metadata can be processed to determine how block allocations should be changed. In some examples, an allocation change may include changing the size of a read or write cache. In other examples, the allocation of the blocks between multiple volumes of the hybrid storage aggregate may be modified.

These techniques provide the ability to do a more detailed analysis of how blocks are being used and enable the cache in a hybrid storage aggregate to be dynamically allocated as the operating environment or the needs of the system change. Dynamic allocation alleviates the rigidity of hard allocations which may not be readily modified.

Embodiments of the present invention also include other methods, systems with various components, and non-transitory machine-readable storage media storing instructions which, when executed by one or more processors, direct the one or more processors to perform the methods, variations of the methods, or other operations described herein. While multiple embodiments are disclosed, still other embodiments will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present invention will be described and explained through the use of the accompanying drawings in which:

FIG. 1 illustrates an operating environment in which some embodiments of the present invention may be utilized;

FIG. 2 illustrates a storage server system in which some embodiments of the present invention may be utilized;

FIG. 3A illustrates an example of read caching in a hybrid storage aggregate;

FIG. 3B illustrates an example of write caching in a hybrid storage aggregate;

FIG. 4 illustrates an example of a method of operating a hybrid storage aggregate according to one embodiment of the invention;

FIG. 5 illustrates the allocation of storage blocks in a hybrid storage aggregate;

FIG. 6 illustrates the allocation of storage blocks in a hybrid storage aggregate which includes multiple volumes.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments are shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Some data storage systems, such as hybrid storage aggregates, include persistent storage space which is made up of different types of storage devices with different latencies. The low latency devices typically offer better performance, but typically have cost and/or other drawbacks. Implementing only a portion of a storage system with low latency devices provides some system performance improvement without incurring the full cost or other limitations associated with implementing the entire storage system with the lower latency storage devices. The system performance improvement may be optimized by selectively caching the most frequently accessed data (i.e., the hot data) in the lower latency devices. This configuration maximizes the number of reads and writes to the system which will occur in the faster, lower latency devices. In many cases, the storage space available in a storage system is assigned for use at the block level. As used herein, a “block” of data is a contiguous set of data of a known length starting at a particular address value. In some embodiments, each block is 4 kBytes in length. However, the blocks could be other sizes.

The assigned blocks of the low latency storage devices are typically used as a read cache or a write cache for the storage system. As used herein, a “read cache” generally refers to at least one data block in a lower latency tier of the storage system which contains a higher performance copy of “read cached” data which is stored in a higher latency tier of the storage system. A “write cache” generally refers to at least one data block which is located in the lower latency tier for purposes of write performance. Write cache blocks may not have a corresponding copy of the data they contain stored in the higher latency tier. In addition, blocks of the lower latency tier may be used for other purposes. For example, blocks of the lower latency tier may be used for storage of metadata, for special read cache which is not included in the allocated storage space (i.e., unallocated read cache), or for other purposes.

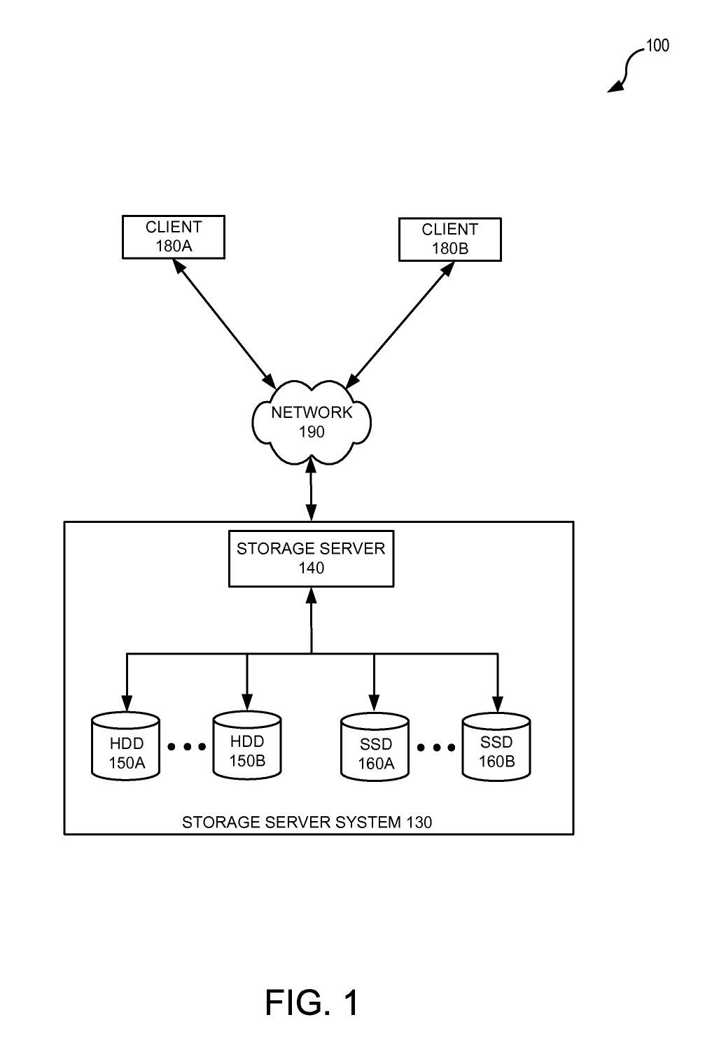

FIG. 1 illustrates an operating environment 100 in which some embodiments of the techniques introduced here may be utilized. Operating environment 100 includes storage server system 130, clients 180A and 180B, and network 190.

Storage server system 130 includes storage server 140, HDD 150A, HDD 150B, SSD 160A, and SSD 160B. Storage server system 130 may also include other devices or storage components of different types which are used to manage, contain, or provide access to data or data storage resources. Storage server 140 is a computing device that includes a storage operating system that implements one or more file systems. Storage server 140 may be a server-class computer that provides storage services relating to the organization of information on writable, persistent storage media such as HDD 150A, HDD 150B, SSD 160A, and SSD 160B. HDD 150A and HDD 150B are hard disk drives, while SSD 160A and SSD 160B are solid state drives (SSD).

A typical storage server system can include many more HDDs and/or SSDs than are illustrated in FIG. 1. It should be understood that storage server system 130 may be also implemented using other types of persistent storage devices in place of, or in combination with, the HDDs and SSDs. These other types of persistent storage devices may include, for example, flash memory, NVRAM, MEMs storage devices, or a combination thereof. Storage server system 130 may also include other devices, including a storage controller, for accessing and managing the persistent storage devices. Storage server system 130 is illustrated as a monolithic system, but could include systems or devices which are distributed among various geographic locations. Storage server system 130 may also include additional storage servers which operate using storage operating systems which are the same or different from storage server 140.

Storage server 140 manages data stored in HDD 150A, HDD 150B, SSD 160A, and SSD 160B. Storage server 140 also provides access to the data stored in these devices to clients such as client 180A and client 180B. According to the techniques described herein, storage server 140 also updates metadata associated with assigned data blocks of SSD 160A and SSD 1608 where the metadata includes information about how the blocks are being used. Storage server 140 processes the metadata to determine caching characteristics of the blocks. The teachings of this description can be adapted to a variety of storage server architectures including, but not limited to, a network-attached storage (NAS), storage area network (SAN), or a disk assembly directly-attached to a client or host computer. The term “storage server” should therefore be taken broadly to include such arrangements.

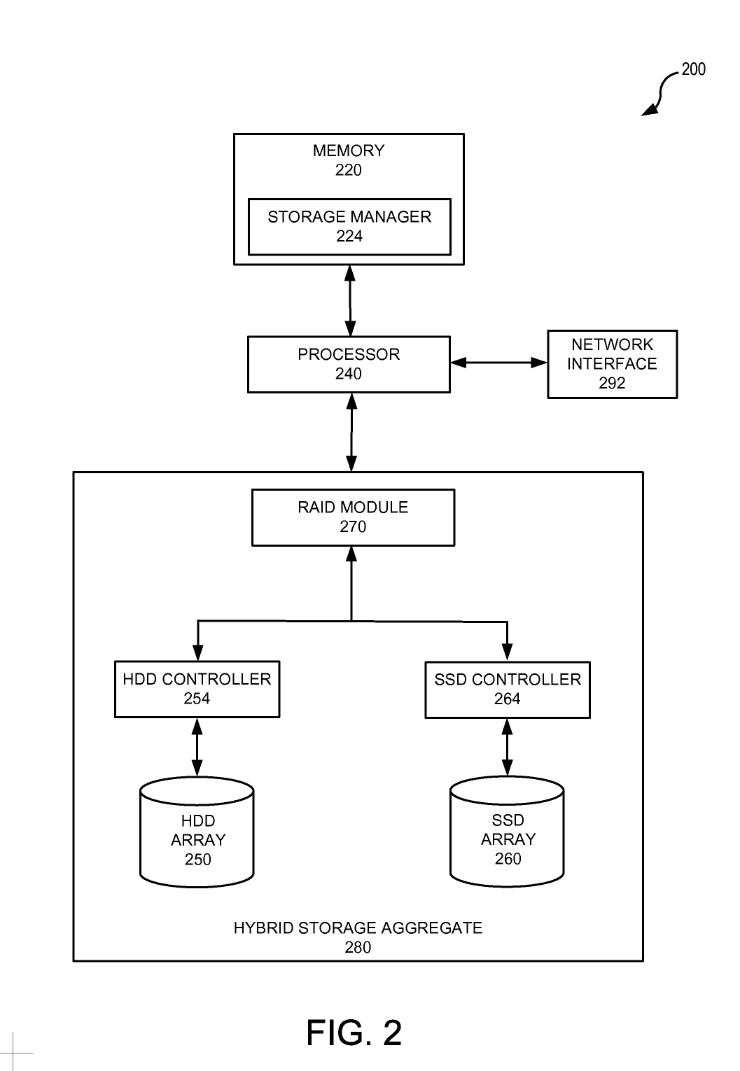

FIG. 2 illustrates storage server system 200 in which some embodiments of the techniques introduced here may also be utilized. Storage server system 200 includes memory 220, processor 240, network interface 292, and hybrid storage aggregate 280. Hybrid storage aggregate 280 includes HDD array 250, HDD controller 254, SSD array 260, SSD controller 264, and RAID module 270. HDD array 250 and SSD array 260 are heterogeneous tiers of persistent storage media. HDD array 250 includes relatively inexpensive, higher latency magnetic storage media devices constructed using disks and read/write heads which are mechanically moved to different locations on the disks. HDD 150A and HDD 150B are examples of the devices which make up HDD array 250. SSD array 260 includes relatively expensive, lower latency electronic storage media 340 constructed using an array of non-volatile, flash memory devices. SSD 160A and SSD 1608 are examples of the devices which make up SSD array 260. Hybrid storage aggregate 280 may also include other types of storage media of differing latencies. The embodiments described herein are not limited to the HDD/SSD configuration and are not limited to implementations which have only two tiers of persistent storage media. Hybrid storage aggregates including three or more tiers of storage are possible. In these implementations, each tier may be operated as a cache for another tier in a hierarchical fashion.

Hybrid storage aggregate 280 is a logical aggregation of the storage in HDD array 250 and SSD array 260. In this example, hybrid storage aggregate 280 is a collection of RAID groups which may include one or more volumes. RAID module 270 organizes the HDDs and SSDs within a particular volume as one or more parity groups (e.g., RAID groups) and manages placement of data on the HDDs and SSDs. In at least one embodiment, data are stored by hybrid storage aggregate 280 in the form of logical containers such as volumes, directories, and files. A “volume” is a set of stored data associated with a collection of mass storage devices, such as disks, which obtains its storage from (i.e., is contained within) an aggregate, and which is managed as an independent administrative unit, such as a complete file system. Each volume can contain data in the form of one or more files, directories, subdirectories, logical units (LUNs), or other types of logical containers.

RAID module 270 further configures RAID groups according to one or more RAID implementations to provide protection in the event of failure of one or more of the HDDs or SSDs. The RAID implementation enhances the reliability and integrity of data storage through the writing of data “stripes” across a given number of HDDs and/or SSDs in a RAID group including redundant information (e.g., parity). HDD controller 254 and SSD controller 264 perform low level management of the data which is distributed across multiple physical devices in their respective arrays. RAID module 270 uses HDD controller 254 and SSD controller 264 to respond to requests for access to data in HDD array 250 and SSD array 260.

Memory 220 includes storage locations that are addressable by processor 240 for storing software programs and data structures to carry out the techniques described herein. Processor 240 includes circuitry configured to execute the software programs and manipulate the data structures. Storage manager 224 is one example of this type of software program. Storage manager 224 directs processor 240 to, among other things, implement one or more file systems. Processor 240 is also interconnected to network interface 292. Network interface 292 enables devices or systems, such as client 180A and client 1808, to read data from or write data to hybrid storage aggregate 280.

In one embodiment, storage manager 224 implements data placement or data layout algorithms that improve read and write performance in hybrid storage aggregate 280. Data blocks in SSD array 260 are assigned for use in storing data. The blocks may be used as a read cache, as a write cache, or for other purposes. Generally, the objective is to use the blocks of SSD array 260 to store the data of hybrid storage aggregate 280 which is most frequently accessed. In some cases, data blocks which are often randomly accessed may also be cached in SSD array 260. In the context of this explanation, the term “randomly” accessed, when referring to a block of data, pertains to whether the block of data is accessed in conjunction with accesses of other blocks of data stored in the same physical vicinity as that block on the storage media. Specifically, a randomly accessed block is a block that is accessed not in conjunction with accesses of other blocks of data stored in the same physical vicinity as that block on the storage media. While the randomness of accesses typically has little or no effect on the performance of solid state storage media, it can have significant impacts on the performance of disk based storage media due to the necessary movement of the mechanical drive components to different physical locations of the disk. A significant performance benefit may be achieved by relocating a data block that is randomly accessed to a lower latency tier, even though the block may not be accessed frequently enough to otherwise qualify it as hot data. Consequently, the frequency of access and nature of the accesses (i.e., whether the accesses are random) may be jointly considered in determining which data should be located to a lower latency tier.

Storage manager 224 can be configured to modify, over time, how the blocks of SSD array 260 are allocated and used in order to improve system performance. For example, storage manager 224 may change the size of a cache implemented in SSD array 260 in order to improve system performance or make better use of the some of the blocks. Storage manager 224 may dynamically modify these allocations without a system administrator manually configuring the system to perform hard allocations. In some cases hard or fixed allocations may not be used and the blocks may be allocated upon use.

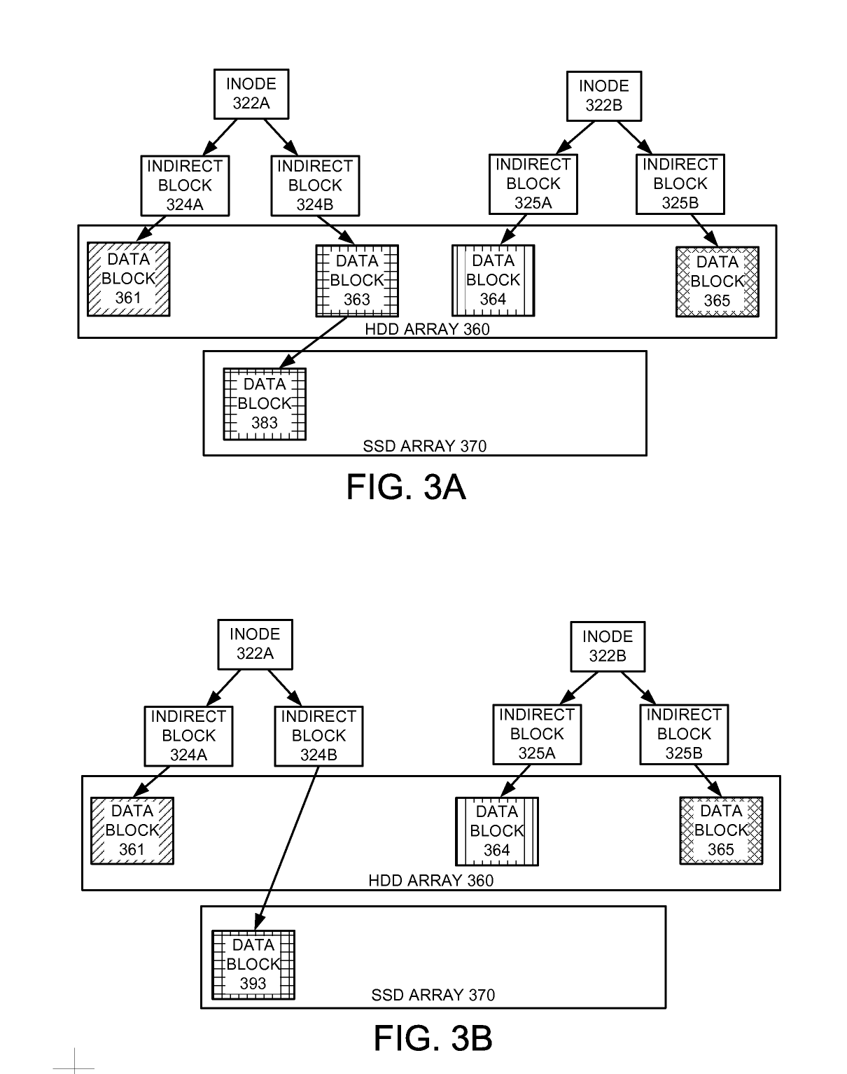

FIG. 3A illustrates an example of a read cache in a hybrid storage aggregate such as hybrid storage aggregate 280. A read cache is a copy, created in a lower latency storage tier, of a data block that is stored in the higher latency tier and is being read frequently (i.e., the data block is hot). In other cases a block in the high latency tier may be read cached because it is frequently read randomly. A significant performance benefit may be achieved by relocating a data block that is randomly accessed to a lower latency tier, even though the block may not be accessed frequently enough to otherwise qualify it as hot data. Consequently, the frequency of access and nature of the access (i.e., whether the accesses are random) may be jointly considered in determining which data should be located to a lower latency tier.

Information about the locations of data blocks of files stored in a hybrid storage aggregate can be arranged in the form of a buffer tree. A buffer tree is a hierarchical data structure that contains metadata about a file, including pointers for use in locating the blocks of data which make up the file. These blocks of data often are not stored in sequential physical locations and may be spread across many different physical locations or regions of the storage arrays. Over time, some blocks of data may be moved to other locations while other blocks of data of the file are not moved. Consequently, the buffer tree operates as a lookup table to locate all of the blocks of a file.

A buffer tree includes an inode and one or more levels of indirect blocks that contain pointers that reference lower-level indirect blocks and/or the direct blocks where the data are stored. An inode may also store metadata about the file, such as ownership of the file, access permissions for the file, file size, file type, in addition to the pointers the direct and indirect blocks. The inode is typically stored in a separate inode file. The inode is the starting point for finding the locations of all of the associated data blocks that make up the file. Determining the actual physical location of a block may require working through the inode and one or more levels of indirect blocks

FIG. 3A illustrates two buffer trees, one associated with inode 322A and another associated with inode 322B. (node 322A points to or references level 1 indirect blocks 324A and 324B. Each of these indirect blocks points to the actual physical storage locations of the data blocks which store the data. In some cases, multiple levels of indirect blocks are used. An indirect block may point to another indirect block where the latter indirect block points to the physical storage location of the data. Additional layers of indirect blocks are possible.

The fill patterns of the data blocks illustrated in FIG. 3A are indicative of the content of the data blocks. For example, data block 363 and data block 383 contain identical data. At a previous point in time, data block 363 was determined to be hot and a copy of data block 363 was created in SSD array 370 (i.e., data block 383). Metadata associated with data block 363 in indirect block 324B was updated such that requests to read data block 363 are pointed to data block 383. HDD array 350 is bypassed when reading this block. The performance of the storage system is improved because the data can be read from data block 383 more quickly than it could be from data block 363. Typically many more data blocks will be included in a read cache. Only one block is illustrated in FIG. 3A for purposes of illustration. None of the data blocks associated with inode 322B are cached in this example.

FIG. 3B illustrates an example of a write cache in a hybrid storage aggregate, such as hybrid storage aggregate 280. In FIG. 3B, data block 393 is a write cache block. The data of data block 393 was previously identified as having a high write frequency relative to other blocks (i.e., it was hot) and was written to SSD array 370 rather than HDD array 360. When data block 393 was written to SSD array 370, indirect block 324B was changed to indicate the new physical location of the data block. Each of the subsequent writes to data block 393 is completed more quickly because the block is located in lower latency SSD array 370. In this example of write caching, a copy of the data cached in data block 393 is not retained in HDD array 360. In other words, in the example of write caching illustrated in FIG. 3B, there is no data block analogous to data block 363 of FIG. 3A. This configuration is preferred for write caching because a copy of data block 393 in HDD array 360 would also have to be written each time data block 393 is written. This would eliminate or significantly diminish the performance benefit of having data block 393 stored in SSD array 370. Typically many more data blocks will be included in a write cache. Only one block is illustrated in FIG. 3B for purposes of illustration. None of the data blocks associated with inode 322B are cached in this example.

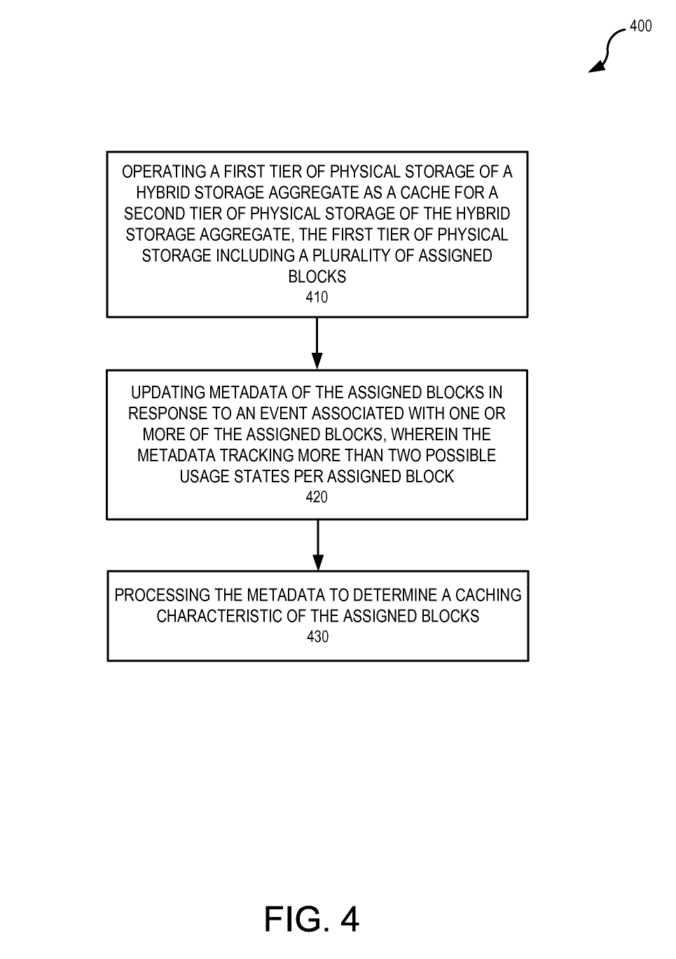

FIG. 4 illustrates a method 400 of operating a hybrid storage aggregate according to one embodiment of the invention. Method 400 is described here with respect to storage system 200 of FIG. 2, but method 400 could be implemented in many other systems. Method 400 includes processor 240 operating a first tier of physical storage of hybrid storage aggregate 280 as a cache for a second tier of physical storage of hybrid storage aggregate 280 (step 410). In this example, the first tier of physical storage is SSD array 260 and the second tier of physical storage is HDD array 250. The first tier of physical storage includes a plurality of data storage blocks which have been assigned for use. Method 400 includes processor 240 updating metadata of these assigned blocks in response to an event associated with at least one of the assigned blocks (step 420). The metadata includes block usage information tracking more than two possible usage states per assigned block. Method 400 also includes processing the metadata to determine a caching characteristic of the assigned blocks (step 430).

The caching characteristic determined in step 430 may include information indicating whether the block is being used as a write cache block or a read cache block. The caching characteristic may also include information indicating how frequently the block has been read, how frequently the block has been written, and/or a temperature of the block. The temperature of the block is a categorical indication of whether or not a block has been accessed more frequently than a preset threshold. For example, a block which has been accessed more than a specified number of times in a designated period may be designated as a “hot” block while a block which has been accessed fewer than the specified number of times in the designated period may be designated as “cold.” More than two categorical levels of block temperature are possible. The caching characteristic may also include information about the assignment of a block. The caching characteristic may also include other types of information which indicates how an assigned block is being used in the system.

In a variation of method 400, processor 240 may also change allocations of the assigned blocks of SSD array 260 based on at least one of the described caching characteristics. For example, processor 240 may increase or decrease the size of either a read cache or a write cache in SSD array 260 based on a caching characteristic. In the case where multiple volumes are stored in storage system 200, the metadata may be analyzed on a per volume basis in order to determine at least one caching characteristic of the assigned blocks which are assigned to a particular volume of the volumes. In response to this analysis, the allocation of the assigned blocks among the multiple volumes may be changed. This may include changing the size of read caches and/or write caches of the volumes with respect to each other. In other words, the size of the caches may be balanced among the volumes based on the analysis.

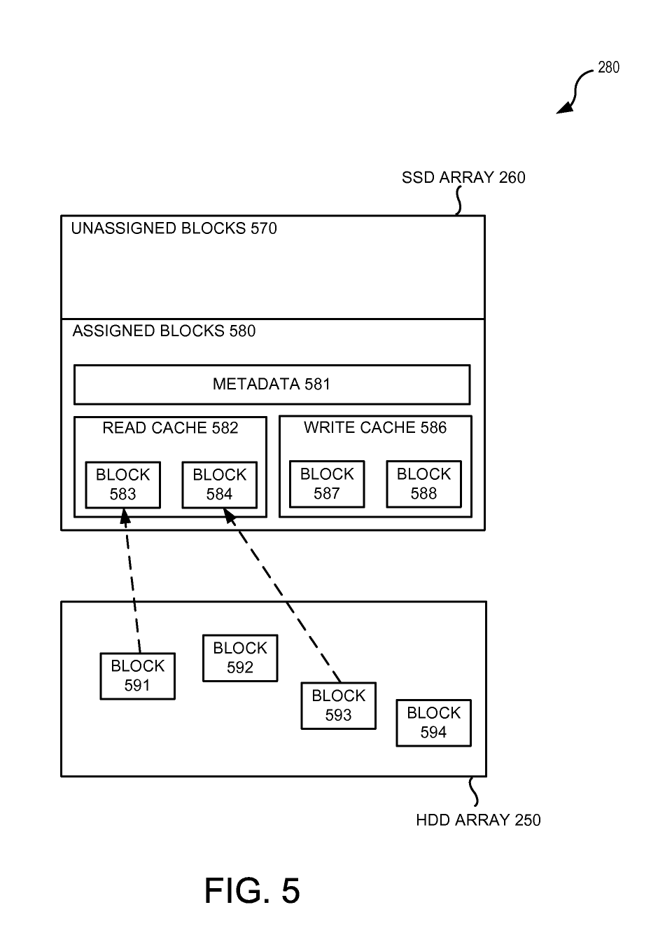

FIG. 5 illustrates an allocation of storage blocks in hybrid storage aggregate 280. As described previously, hybrid storage aggregate 280 includes HDD array 250 and SSD array 260. The lower latency storage devices of SSD array 260 are operated as a cache for the higher latency storage devices of HDD array 250 in order to improve responsiveness and performance of storage system 200. Some of the storage space in SSD array 260 may also be used for other purposes including storage of metadata, buffer trees, and/or storage of other types of data including system management data.

SSD array 260 includes assigned blocks 580 and unassigned blocks 570. Assigned blocks 580 and unassigned blocks 570 are not physically different or physically separated. They only differ in how they are categorized and used in hybrid storage aggregate 280. Assigned blocks 580 have been assigned to be used for storage of data and unassigned blocks 570 have not been assigned for use. Unassigned blocks 570 are not typically available for use by RAID module 270 and/or SSD array 260. In some cases, all of the blocks in SSD array 260 will be assigned and unassigned blocks 570 will not include any blocks. In other cases, blocks may be reserved in unassigned blocks 570 to accommodate future system growth or to accommodate periods of peak system usage. Processor 240, in conjunction with storage manager 224, manages the assignment and use of assigned blocks 580 and unassigned blocks 570.

In the example of FIG. 5, assigned blocks 580 of SSD array 260 include storage of metadata 581 as well as read cache 582 and write cache 586. The storage space available in assigned blocks 580 may also be used for other purposes. Assigned blocks 580 may also be used to store multiple read caches and/or multiple write caches. Metadata 581 includes block usage information describing the usage of assigned blocks 580 on a per block basis. It should be understood that metadata 581 may also be stored in another location, including HDD array 250.

HDD array 250 of FIG. 5 includes data block 591, data block 592, data block 593, and data block 594. Many more data blocks are typical, but only a small number of blocks is included for purposes of illustration. Although each of the data blocks is illustrated as a monolithic block, the data which makes up each block may be spread across multiple HDDs. Read cache 582 and write cache 586 each contain data blocks. Read cache 582 and write cache 586 are not physical devices or structures. They illustrate block assignments and logical relationships within SSD array 260. Specifically, they illustrate how processor 240 and storage manager 224 use assigned blocks 580 of SSD array 260 for caching purposes.

In FIG. 5, block 583 of read cache 582 is a read cache for block 591 of HDD array 250. Typically, block 583 is described as a read cache block and block 591 is described as the read cached block. Block 583 contains a copy of the data of block 591. When a request to read block 591 is received by storage system 200, the request is satisfied by reading block 583. Block 584 and block 593 have a similar read cache relationship. Block 584 is a read cache for block 593 and contains a copy of the data in block 593. Block 587 and block 588 of write cache 586 are write cache blocks. At some point in time block 587 and block 588 may have been stored in HDD array 250, but were write cached and the data relocated to write cache 586. Typically, write cache blocks, such as block 587 and block 588, do not have a corresponding copy in HDD array 250.

At a prior point in time, the storage blocks used to store data blocks 583, 584, 587, and 588 was assigned for use. These storage blocks were previously included in unassigned blocks 570 and were put into use thereby logically becoming part of assigned blocks 580. As illustrated, the assigned blocks may be used for read cache, for write cache, or for storage of metadata. The assigned blocks may also be used for other purposes including storing system management data or administrative data. Prior art systems track two possible usage states of the blocks which make up SSD array 260. The two possible usage states are assigned or unassigned.

In FIG. 5, processor 240 and storage manager 224 track block usage information of the assigned blocks. The block usage information includes information with more detail than the two usage states of prior art systems. The block usage information is included in metadata 581. The block usage information may indicate a type of cache block (i.e., read cache or write cache), a read and/or write frequency of the block, a temperature of the block, a lifetime read and/or write total for the block, an owner of the block, a volume the block is assigned to, or other usage information.

In one example metadata 581 includes a time and temperature map (TTMap) for each of the assigned blocks of SSD array 260. The TTMap may be an entry which includes a block type, a temperature, a pool id, and a reference count. The block type and the temperature are described above. The pool id and the reference count further describe usage of the block. A pool refers to a logical partitioning of the blocks of SSD array 260. A pool may be created for a specific use, such as a write cache, a read cache, a specific volume, a specific file, other specific uses, or combinations thereof. A pool may be dedicated to use as a read cache for a specific volume. A pool may also be allocated for storage of metafiles. The pool ID is the identifier of a pool.

In another example, metadata 581 may include a counter map which includes statistics related to various elements of the TTMap. These statistics may include, for example, statistics relating to characteristics of blocks of a particular type, numbers of references to these blocks, temperature of these blocks, or other related information. Metadata 581 may also include an OwnerMap. An OwnerMap includes information about ownership of assigned blocks.

The various fields which make up metadata 581 are updated as the assigned blocks are used. In one example, the metadata are updated in response to an event associated with one of the assigned blocks. An event may include writing of the block, reading of the block, freeing of the block, or a change in the access frequency of the block. A block may be freed when it is no longer actively being used to store data but has not been unassigned. An event may also include other interactions with a block or operations performed on a block. Metadata 581 is processed to determine usage or caching characteristics of any individual block or combination of blocks of assigned blocks 580. The results of the processing can be used to create a detailed accounting of how read cache 582 and/or write cache 586 are being used.

Processor 240 and storage manager 224 may use the accounting described above to change an allocation of assigned blocks 580. In one example, the processing of metadata 581 may indicate that all or a majority of the assigned blocks are being heavily utilized. In this case, assignment of additional blocks of unassigned blocks 570 may improve system performance. These additional blocks may be used to increase the size of read cache 582, write cache 586, or both.

In another example, metadata 581 may be processed in a manner such that the usage or caching characteristics of read cache 582 and write cache 586 are separately identified. Collective usage information for read cache 582 and write cache 586 can be generated by separately aggregating the block usage information of the individual blocks which make up each of the caches. Processing the aggregated block usage information may indicate that a size of one of the caches should be changed in order to maintain or improve system performance, while a size of the other cache remains unchanged. The size of the cache is changed by assigning additional blocks for use by the cache.

In another example, the processing of the separately aggregated block usage information may indicate that one cache is being heavily utilized while another is not. In this case, the blocks of either read cache 582 or write cache 586 may be de-allocated from one cache and re-allocated to the other cache. This may be appropriate when one of the caches is being under utilized while the other cache is being over utilized. The sizes of the caches may also be adjusted based on their relative sizes, their usage frequencies, or based on other factors. Metadata 581, which includes individual block usage information, enables various types of block usage accounting and/or analysis to be performed in order to better understand the how the assigned blocks are being used. It may also be used to make allocation decisions to optimize the use or performance of SSD array 260.

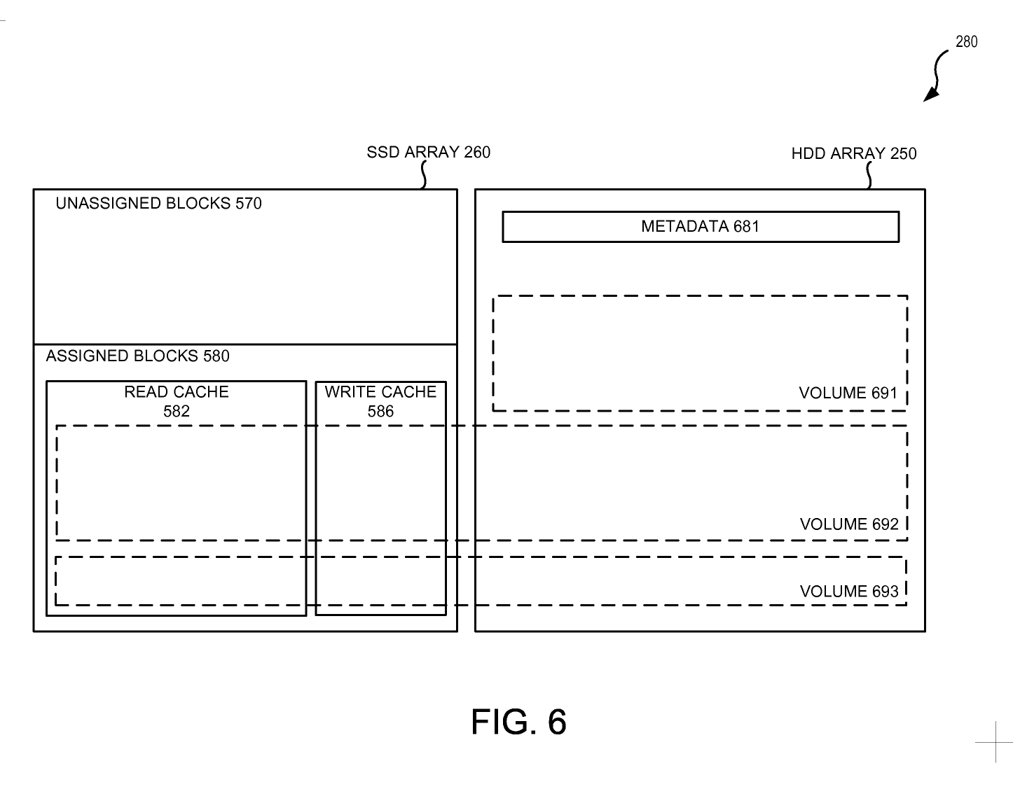

FIG. 6 illustrates the allocation of storage blocks in hybrid storage aggregate 280 in a configuration that includes storing multiple volumes. In this example, volume 691, volume 692, and volume 693 are stored in hybrid storage aggregate 280. All of the data associated with volume 691 is stored in HDD array 250 while volume 692 and volume 693 are both read and write cached using blocks of SSD array 260. The read and write caches operate as described in previous examples. In this example, the metadata are stored in HDD array 250 rather than in SSD array 260 as in FIG. 5. In this example, metadata 681 also includes information about indicating which of the volumes is using (i.e., owns) each of the assigned blocks. In some cases, the information indicating assignment of blocks to specific volumes may be stored in metadata 681 in the form of an OwnerMap. An OwnerMap is a file within metadata 681 which includes information about ownership of assigned blocks.

As described in the previous examples, many different types of allocation decisions may be made based on the caching characteristics which are determined from the processing of metadata 581 or metadata 681. In the case of FIG. 6, the information in metadata 681 that indicates which volume is using a block may include other caching characteristics of the block as described in previous examples. These caching characteristics may be used in conjunction with the volume use information to make allocation determinations. In some cases, metadata 681 may also contain block usage information of blocks which are not owned or used by the volumes.

In one example, block usage information of all blocks of read cache 582 which are being used by volume 692 may be collectively analyzed relative to the collective block usage information of all blocks of read cache 582 which are being used by volume 693. The analysis may indicate that read cache blocks associated with volume 692 are being used much more frequently than the read cache blocks associated with volume 692. A performance improvement may be achieved by allocating more read cache blocks to volume 693. Because the read cache blocks associated with volume 692 are not being used as frequently, some of these blocks may be reallocated for use by volume 693.

In other examples, additional blocks may be allocated to read cache 582 from write cache 586 or from unassigned blocks 570. In another example, relatively low usage of read cache 582 and/or write cache 586 may justify allocating some of the blocks of one or both of these caches for use by volume 691 even though it is not presently cached. These types of block allocation decisions may be made dynamically based on many different permutations of the block usage information tracked in metadata 681. Many different performance enhancement strategies based on the block usage information are possible.

Embodiments of the present invention include various steps and operations, which have been described above. A variety of these steps and operations may be performed by hardware components or may be embodied in machine-executable instructions, which may be used to cause one or more general-purpose or special-purpose processors programmed with the instructions to perform the steps. Alternatively, the steps may be performed by a combination of hardware, software, and/or firmware.

Embodiments of the present invention may be provided as a computer program product which may include a machine-readable medium having stored thereon non-transitory instructions which may be used to program a computer or other electronic device to perform some or all of the operations described herein. The machine-readable medium may include, but is not limited to optical disks, compact disc read-only memories (CD-ROMs), magneto-optical disks, floppy disks, ROMs, random access memories (RAMs), erasable programmable read-only memories (EPROMs), electrically erasable programmable read-only memories (EEPROMs), magnetic or optical cards, flash memory, or other type of machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link.

The phrases “in some embodiments,” “according to some embodiments,” “in the embodiments shown,” “in other embodiments,” “in some examples,” and the like generally mean the particular feature, structure, or characteristic following the phrase is included in at least one embodiment of the present invention, and may be included in more than one embodiment of the present invention. In addition, such phrases do not necessarily refer to the same embodiments or different embodiments.

While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof. Therefore, the above description should not be taken as limiting the scope of the invention, which is defined by the claims.

What is claimed is:

1. A method comprising:
operating a first tier of physical storage of a hybrid storage aggregate as a cache for a second tier of physical storage of the hybrid storage aggregate, the first tier of physical storage including a plurality of assigned blocks;
updating metadata of the assigned blocks in response to an event associated with at least one of the assigned blocks, wherein the metadata includes block usage information tracking more than two possible usage states per assigned block; and
processing the metadata to determine a caching characteristic of the assigned blocks.

2. The method of claim 1 further comprising changing an allocation of the assigned blocks based on the caching characteristic.

3. The method of claim 1 wherein persistent storage media of the first tier of physical storage includes a solid state storage device and persistent storage media of the second tier of physical storage includes a disk based storage device.

4. The method of claim 1 wherein the plurality of assigned blocks includes blocks operated as a read cache for the second tier of physical storage and includes blocks operated as a write cache for the second tier of physical storage.

5. The method of claim 4 further comprising changing an allocation of the assigned blocks based on the caching characteristic, wherein changing the allocation includes changing a size of the read cache or changing a size of the write cache.

6. The method of claim 4 further comprising changing an allocation of the assigned blocks based on the caching characteristic, wherein changing the allocation includes changing a size of the read cache based on a relationship between the size of the read cache and a size of the write cache or changing the size of the write cache based on the relationship between the size of the read cache and the size of the write cache.

7. The method of claim 4 further comprising changing an allocation of the assigned blocks based on the caching characteristic, wherein:
the metadata includes an access frequency of the read cache and an access frequency of the write cache; and
changing the allocation includes changing a size of the read cache based on at least one of the access frequencies or changing a size of the write cache based on at least one of the access frequencies.

8. The method of claim 1 wherein the hybrid storage aggregate includes a plurality of volumes that span the first and the second tiers of physical storage.

9. The method of claim 8 wherein:
a subset of the assigned blocks is associated with a volume of the plurality of volumes;
processing the metadata includes determining volume usage information of the subset of the assigned blocks; and
changing the allocation includes changing a size of the subset of the assigned blocks based on the volume usage information.

10. The method of claim 1 wherein the metadata includes an access frequency of a block of the assigned blocks.

11. The method of claim 10 wherein the event includes at least one of assigning the block, reading the block, writing the block, freeing the block, or a change in the access frequency of the block.

12. A storage server system comprising:
a processor; and
a memory coupled with the processor and including a storage manager that directs the processor to:
operate a hybrid storage aggregate that includes a first tier of physical storage media and a second tier of physical storage media, the first tier of physical storage media having a latency that is less than a latency of the second tier of physical storage media; and
assign a plurality of blocks of the first tier of physical storage, wherein a first portion of the assigned blocks are operated as a read cache for the second tier of physical storage and a second portion of the assigned blocks are operated as write cache for the second tier of physical storage;
update metadata of the assigned blocks in response to an event associated with at least one of the assigned blocks, wherein the metadata includes block usage information tracking more than two possible usage states per assigned block;
process the metadata to determine a caching characteristic of the assigned blocks; and
change an allocation of the assigned blocks based on the caching characteristic.

13. The storage server system of claim 12 wherein the first tier of physical storage media includes a solid state storage device and the second tier of physical storage includes a disk based storage device.

14. The storage server system of claim 12 wherein changing the allocation includes changing a size of the read cache or changing a size of the write cache.

15. The storage server system of claim 12 wherein changing the allocation includes changing a size of the read cache based on a relationship between the size of the read cache and a size of the write cache or changing the size of the write cache based on the relationship between the size of the read cache and the size of the write cache.

16. The storage server system of claim 12 wherein:
the metadata includes an access frequency of the read cache and an access frequency of the write cache; and
changing the allocation includes changing a size of the read cache based on at least one of the access frequencies or changing a size of the write cache based on at least one of the access frequencies.

17. The storage server system of claim 12 wherein the hybrid storage aggregate includes a plurality of volumes that span the first and the second tiers of physical storage.

18. The storage server system of claim 17 wherein:
a subset of the assigned blocks is associated with a volume of the plurality of volumes;
processing the metadata includes determining volume usage information of the subset of the assigned blocks; and
changing the allocation includes changing a size of the subset based on the volume usage information.

19. The storage server system of claim 12 wherein the metadata includes an access frequency of a block of the assigned blocks.

20. The storage server system of claim 19 wherein the event includes at least one of assigning the block, reading the block, writing the block, freeing the block, or a change in the access frequency of the block.

21. A non-transitory machine-readable medium comprising non-transitory instructions that, when executed by one or more processors, direct the one or more processors to:
assign a plurality of blocks of a solid state storage array to be operated as a cache for a disk based storage array, a first portion of the plurality of blocks assigned as a read cache for the disk based storage array and a second portion of the plurality of blocks assigned as a write cache for the disk based storage array;
update metadata of the assigned blocks in response to an event associated with at least one of the assigned blocks, wherein the metadata includes block usage information tracking more than two possible usage states per assigned block;
process the metadata to determine a caching characteristic of the assigned blocks; and
change an allocation of the assigned blocks based on the caching characteristic.

22. The non-transitory machine-readable medium of claim 21 wherein changing the allocation includes changing a size of the read cache or changing a size of the write cache.

23. The non-transitory machine-readable medium of claim 21 wherein changing the allocation includes changing a size of the read cache based on a relationship between the size of the read cache and a size of the write cache or changing the size of the write cache based on the relationship between the size of the read cache and the size of the write cache.

24. The non-transitory machine-readable medium of claim 21 wherein:
the metadata includes an access frequency of the read cache and an access frequency of the write cache; and
changing the allocation includes changing a size of the read cache based on at least one of the access frequencies or changing a size of the write cache based on at least one of the access frequencies.

25. The non-transitory machine-readable medium of claim 21 wherein:
a plurality of volumes are stored in a hybrid storage aggregate which includes the disk based storage array and the solid state storage array;
processing the metadata includes determining volume usage information based on a subset of the assigned blocks used in storing a volume of a plurality of volumes; and
changing the allocation includes changing a size of the subset based on the volume usage information.

26. The non-transitory machine-readable medium of claim 21 wherein the metadata includes an access frequency of a block of the assigned blocks.

27. The non-transitory machine-readable medium of claim 26 wherein the event includes at least one of assigning the block, reading the block, writing the block, freeing the block, or a change in the access frequency of the block.

28. A method comprising:
operating a first tier of physical storage of a hybrid storage aggregate as a cache for a second tier of physical storage of the hybrid storage aggregate, the first tier of physical storage including a plurality of blocks;
updating metadata that describes usage states of one or more of the blocks in response to usage of the one or more blocks;
determining a caching characteristic of the one or more blocks based on processing the metadata that describes the usage states of the one or more blocks; and
changing an allocation of the plurality of blocks based on the caching characteristic.

29. The method of claim 28 wherein a first portion of the first tier of physical storage is operated as a read cache for the second tier of physical storage and a second portion of the first tier of physical storage is operated as a write cache for the second tier of physical storage.

30. The method of claim 29 wherein changing the allocation includes changing a size of the read cache or changing a size of the write cache.
